(19) United States
(12) Patent Application Publication
(10) Pub. No.: US 2009/0006397 A1
(43) Pub. Date: Jan. 1, 2009

(54) Systems, Methods, Devices and Computer Program Products for Providing Media Recommendation Trekking

(75) Inventors: Arto Lehtiniemi, Lempaala (FI); Antti Eronen, Tampere (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/771,650

(22) Filed: Jun. 29, 2007

(51) Int. Cl. G06F 17/30

(52) U.S. Cl. 707/7; 707/E17.048

(57) ABSTRACT

An apparatus, method and computer program product are provided to generate a playlist or other sequential list of media items in a game-like manner. A starting media item and a target media item may be initially selected. The system recommends a plurality of media items based on the starting media item. The user selects a media item from these recommendations. The system then recommends another plurality of media items based on the user-selected media item. The user then selects a media item from these recommendations. This process continues until the system recommends and the user selects the target media item. The user generally desires to minimize the steps required to traverse a media collection from the starting media item to the target media item. The path that the user takes to reach the target media item can be stored as a playlist or other sequential list of media items.

### FIELD OF EMBODIMENTS OF THE INVENTION

Embodiments of the invention relate generally to systems, methods, and computer program products configured to provide for media recommendation trekking. More particularly, embodiments of the invention relate to a system for providing a media-related game and/or a new system for generating playlists or other sequential lists of media items.

### BACKGROUND OF EMBODIMENTS OF THE INVENTION

Many people have accumulated large collections of electronic media files, such as digital music files. A problem associated with having so many music files is that a user may have a difficult time selecting which music files to play. A user may have more music files than he or she can easily manage and may resort to picking the same songs or combinations of songs over and over again. Thus, there is a need for new and creative methods for generating interesting playlists. There is also always a demand for new and entertaining computer games and, in particular, computer games that can be played on a mobile terminal, such as a cell phone, PDA, or MP3 player. Embodiments of the present invention may provide a new type of computer game and/or a new system and method for generating playlists.

### BRIEF SUMMARY OF EMBODIMENTS OF THE INVENTION

In light of the foregoing background, exemplary embodiments of the present invention provide an apparatus, method and computer program product configured to allow a user to enjoy a media collection in a game-like manner using a media recommendation system. In general, a starting media item and a target media item are initially selected by the user or automatically by a computer system. The computer system recommends a plurality of media items from the media collection based on the starting media item. The user then selects a media item from these recommendations. The computer then recommends another plurality of media items based on the user-selected media item. The user then selects a media item from these recommendations and the computer then recommends yet another plurality of media items from the collection based on the new user-selected media item. This process continues until the computer recommends and the user selects the target media item. The task of the user is generally to traverse the media collection from the starting media item to the target media item in as few steps as possible. In one embodiment, the path that the user takes to reach the target song can be stored as a playlist or other sequential list of media items.

In more general terms, embodiments of the present invention provide for an apparatus having means, such as a processing device configured to: (1) receive a selection of a first selected media item; (2) generate a first plurality of media items based on the first selected media item; (3) receive a selection of a second selected media item from among the first plurality of media items; and (4) generate a second plurality of media items based on the second selected media item. The processing device may be further configured to receive a third selected media item from among the second plurality of media items and to provide the user with a third plurality of media items based on the third selected media item if the third selected media item is not a predetermined target media item. In such an embodiment, the processing device may not provide the user with a third plurality of media items based on the third selected media item if the third selected media item is the target media item.

In one embodiment of the apparatus, the processing device is configured to generate the first plurality of media items based on the first selected media item by identifying a plurality of media items that are similar to the first selected media item with respect to at least one predetermined property. In such an embodiment, the processing device may be further configured to generate the second plurality of media items based on the second selected media item by identifying a plurality of media items that are similar to the second selected media item with respect to at least one predetermined property. In one embodiment in which the media item is a song, the at least one predetermined property may include, for example, at least one of the song's tempo, frequency, genre, rhythm, lyrics, instrumentation, melody, arrangement, or mood.

In one embodiment, the processing device repeatedly provides the user with a plurality of songs based on the previous selected media item until the selected media item is the same song as a predetermined target media item.

In one embodiment, the apparatus includes a memory that stores the media items from which the first and second plurality of media items are selected. In some embodiments of the apparatus in which the media items are songs, the processing device generates a playlist which includes a representation of each selected song.

Embodiments of the present invention further provide a method involving: (1) receiving a selection of a first selected media item; (2) generating a first plurality of media items based on the first selected media item; (3) receiving a selection of a second selected media item from among the first plurality of media items; and (4) generating a second plurality of media items based on the second selected media item. The method may further involve receiving a third selected media item from among the second plurality of media items; and providing the user with a third plurality of media items based on the third selected media item if the third user selected media item is not the target media item.

In one embodiment of the method, providing the user with the first plurality of media items based on the first selected media item comprises identifying a plurality of media items that are similar to the first selected media item with respect to at least one predetermined property. Furthermore, providing the user with the second plurality of media items based on the second selected media item may comprise identifying a plurality of media items that are similar to the second selected media item with respect to at least one predetermined property. In an embodiment in which the media items are songs, the at least one predetermined property may include, for example, at least one of the song's tempo, frequency, genre, rhythm, lyrics, instrumentation, melody, arrangement, or mood.

In one embodiment, the method may include repeatedly providing the user with a plurality of media items based on the previous selected media item until the selected media item is the same media item as a predetermined target media item. The method may also include generating a playlist or other sequential list including a representation of each selected media item.

Embodiments of the present invention further provide a computer program product comprising at least one computer-readable storage medium having computer-readable program code logic stored therein. The computer-readable program code logic may include: a first code logic configured for receiving a selection of a first selected media item; a second code logic configured for generating a first plurality of media items based on the first selected media item; a third code logic configured for receiving a selection of a second selected media item from among the first plurality of media items; and a fourth code logic configured for providing the user with a second plurality of media items based on the second selected media item. The computer program product may further include a fifth code logic configured for receiving a third selected media item selected from among the second plurality of media items; and a sixth code logic configured for providing the user with a third plurality of media items based on the third selected media item if the third selected media item is not the target media item.

In one embodiment of the computer program product the second code logic for generating the first plurality of media items based on the first selected media item may include code logic configured for identifying a plurality of media items that are similar to the first selected media item with respect to at least one predetermined property. Likewise, the fourth code logic for providing the user with the second plurality of media items based on the second selected media item may include code logic configured for identifying a plurality of media items that are similar to the second selected media item with respect to at least one predetermined property. In one embodiment in which the media items are songs, the at least one predetermined property may include, for example, at least one of the song's tempo, frequency, genre, rhythm, lyrics, instrumentation, melody, arrangement, or mood.

In one embodiment, the computer program product includes code logic for repeatedly providing the user with a plurality of media items based on the previous selected media item until the selected media item is the same media item as a predetermined target media item. In embodiments in which the media items are songs, the computer program product may also include code logic configured for generating a playlist that includes a representation of each selected song.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic block diagram of an electronic device in accordance with an exemplary embodiment of the present invention;

FIG. 2 is a schematic block diagram of one type of system in which embodiments of the present invention may be configured to operate, according to an exemplary embodiment of the present invention;

FIG. 3 is a flow diagram illustrating a process that may be executed by the electronic device of FIG. 1 in accordance with an exemplary embodiment of the present invention;

FIG. 4 is an illustration of a possible path in the music parameter space in accordance with an exemplary embodiment of the present invention; and

FIG. 5 is an illustration of how music recommendation trekking may be displayed to a user in accordance with one embodiment of the present invention.

### DETAILED DESCRIPTION OF EMBODIMENTS OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

As summarized above, embodiments of the present invention generally provide for a game in which a user attempts to traverse a media parameter space from a first media item to a target media item in a minimal amount or a predefined number of steps. In this regard, embodiments of the present invention will be hereinafter described in conjunction with the traversal from the first song to the target song in a minimal or the fewest number of steps. However, other embodiments of the present invention may be equally applicable to efforts to traverse between other types of media items and efforts to traverse from the first song to the target song in a predefined or even the most or largest number of steps.

Regardless of the game's objective, this process of traversing a music collection in a music parameter space is generally referred to herein as “music recommendation trekking” and is described in more detail below. In general, a starting song and a target song are initially selected by the user or automatically by a computer system. The computer system recommends a plurality of songs from a music collection based on the starting song. The recommendations are generally based on how closely a song in the music collection relates to the starting song with respect to one or more music parameters or file characteristics. Songs that are considered similar to the starting song with respect to some predetermined combination of music parameters are recommended to the user. The user then selects the song from the plurality of recommended songs that the user thinks most closely resembles the target song. The computer then recommends another plurality of songs based on the user selected song. The user then selects a song from these new recommendations and the computer then recommends yet another plurality of songs from the collection based on the new user selected song. This process continues until the computer's recommendations include the target song and the user selects the target song. The task of the user is generally to traverse the music collection from the starting song to the target song in as few steps as possible. In one embodiment, the path that the user takes to reach the target song can be stored as a playlist.

For example, Jenny may desire to perform music recommendation trekking with her music collection stored on her mobile phone. Jenny may select a target song at random from her music collection, such as Alanis Morissette's “You Oughta Know.” The target song may instead be selected by the mobile terminal, either with or without input from the user. The user may, for example, select a genre such as ‘pop’, or artist, etc., and based on that selection, the terminal may select a target song, such as “Such a little thing makes such a big difference”. Regardless of the manner in which the target song is selected, the mobile phone may then generate a random list of songs from the music collection and display these songs to Jenny asking Jenny to select the song that she thinks is most closely related to the target song. Jenny may be able to listen to all or part of each of the displayed songs to help her determine which song would be considered to be most like the target song. After Jenny selects a song from the list, the mobile phone generates a new list of songs that the mobile terminal considers to be similar to the selected song with respect to some predetermined music parameter. Again, Jenny is asked to select a song from the list that she thinks most closely resembles the target song with respect to the predetermined parameter. After Jenny selects a song from the list, a new list of songs is generated by the mobile terminal based on the newly selected song. This loop continues until the mobile phone eventually, if Jenny is making good selections, includes the target song in its recommendations and Jenny selects the target song.

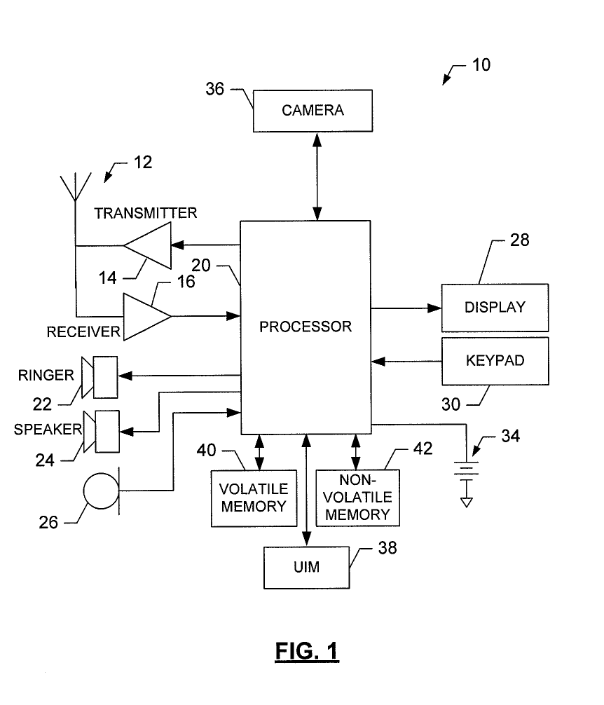

In one embodiment of the present invention, the computer system described above is embodied as a mobile terminal, such as a mobile telephone, or other electronic device. FIG. 1 illustrates a block diagram of an electronic device, and specifically a mobile terminal 10, that may benefit from embodiments of the present invention. While several embodiments of the mobile terminal 10 are illustrated and will be hereinafter described for purposes of example, other types of electronic devices, such as digital cameras, portable digital assistants (PDAs), pagers, mobile televisions, computers, laptop computers, and other types of systems that manipulate and/or store data files, can readily employ embodiments of the present invention. Such devices may or may not be mobile.

The mobile terminal 10 includes a communication interface comprising an antenna 12 in operable communication with a transmitter 14 and a receiver 16. The mobile terminal 10 further includes means, such as a processing device, e.g., a processor 20 or other processing element, that provides signals to and receives signals from the transmitter 14 and receiver 16, respectively. The signals include signaling information in accordance with the air interface standard of the applicable cellular system, and also user speech and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second and/or third-generation communication protocols or the like. For example, the mobile terminal 10 may be capable of operating in accordance with second-generation (2G) wireless communication protocols IS-136 (TDMA), GSM, and IS-95 (CDMA) or third-generation wireless communication protocol Wideband Code Division Multiple Access (WCDMA).

It is understood that the processor 20 includes circuitry required for implementing audio and logic functions of the mobile terminal 10. For example, the processor 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The processor 20 thus may also include the functionality to convolutionally encode and interleave message and data prior to modulation and transmission. The processor 20 can additionally include an internal voice coder, and may include an internal data modem. Further, the processor 20 may include functionality to operate one or more software programs, which may be stored in memory. For example, the processor 20 may be capable of operating a connectivity program, such as a conventional Web browser. The connectivity program may then allow the mobile terminal 10 to transmit and receive Web content, such as location-based content, according to a Wireless Application Protocol (WAP), for example.

The mobile terminal 10 also comprises a user interface including an output device such as a conventional earphone or speaker 24, a ringer 22, a microphone 26, a display 28, and a user input interface, all of which are coupled to the processor 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other keys used for operating the mobile terminal 10. Alternatively, the keypad 30 may include a conventional QWERTY keypad. The mobile terminal 10 further includes a battery 34, such as a vibrating battery pack, for powering various circuits that are required to operate the mobile terminal 10, as well as optionally providing mechanical vibration as a detectable output.

In an exemplary embodiment, the mobile terminal 10 includes a camera 36 in communication with the processor 20. The camera 36 may be any means for capturing an image for storage, display or transmission. For example, the camera 36 may include a digital camera capable of forming a digital image file from a captured image. As such, the camera 36 includes all hardware, such as a lens or other optical device, and software necessary for creating a digital image file from a captured image. Alternatively, the camera 36 may include only the hardware needed to view an image, while a memory device of the mobile terminal 10 stores instructions for execution by the processor 20 in the form of software necessary to create a digital image file from a captured image. In an exemplary embodiment, the camera 36 may further include a processing element such as a co-processor which assists the processor 20 in processing image data and an encoder and/or decoder for compressing and/or decompressing image data. The encoder and/or decoder may encode and/or decode according to a JPEG standard format.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an EEPROM, flash memory or the like. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10.

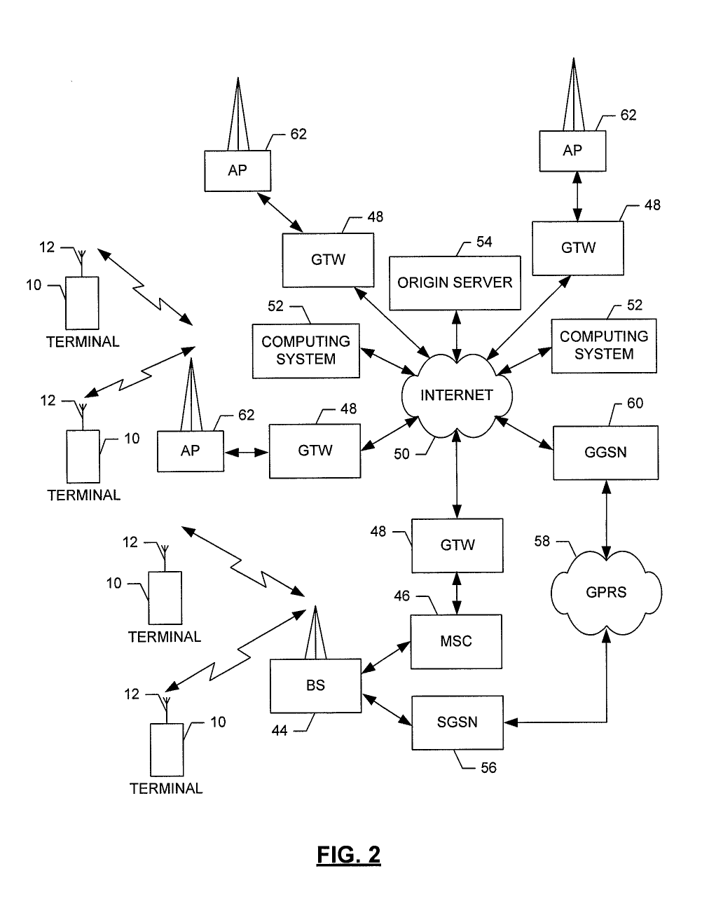

Referring now to FIG. 2, an illustration is provided of one type of system in which embodiments of the present invention may be configured to operate. The system includes a plurality of network devices. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 2, the MSC 46 is merely an exemplary network device and embodiments of the present invention are not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a GTW 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a computing system 52 (two shown in FIG. 2), origin server 54 (one shown in FIG. 2) or the like, as described below.

The BS 44 can also be coupled to a signaling GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a GTW GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or origin server 54 may be coupled to the mobile terminal 10 via the Internet 50, SGSN 56 and GGSN 60. In this regard, devices such as the computing system 52 and/or origin server 54 may communicate with the mobile terminal 10 across the SGSN 56, GPRS core network 58 and the GGSN 60. By directly or indirectly connecting mobile terminals 10 and the other devices (e.g., computing system 52, origin server 54, etc.) to the Internet 50, the mobile terminals 10 may communicate with the other devices and with one another, such as according to the Hypertext Transfer Protocol (HTTP), to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) can be capable of supporting communication in accordance with any one or more of a number of first-generation (1G), second-generation (2G), 2.5G, third-generation (3G) and/or future mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), Bluetooth (BT), infrared (IrDA) or any of a number of different wireless networking techniques, including wireless LAN (WLAN) techniques such as IEEE 802.11 (e.g., 802.11a, 802.11b, 802.11 g, 802.11n, etc.), WiMAX techniques such as IEEE 802.16, and/or ultra wideband (UWB) techniques such as IEEE 802.15 or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the origin server 54, and/or any of a number of other devices, to the Internet 50, the mobile terminals 10 can communicate with one another, the computing system, etc., to thereby carry out various functions of the mobile terminals 10, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of the present invention.

Although not shown in FIG. 2, in addition to or in lieu of coupling the mobile terminal 10 to computing systems 52 across the Internet 50, the mobile terminal 10 and computing system 52 may be coupled to one another and communicate in accordance with, for example, RF, BT, IrDA or any of a number of different wireline or wireless communication techniques, including LAN, WLAN, WiMAX and/or UWB techniques. One or more of the computing systems 52 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the computing systems 52, the mobile terminal 10 may be configured to communicate with the portable electronic devices in accordance with techniques such as, for example, RF, BT, IrDA or any of a number of different wireline or wireless communication techniques, including USB, LAN, WLAN, WiMAX and/or UWB techniques.

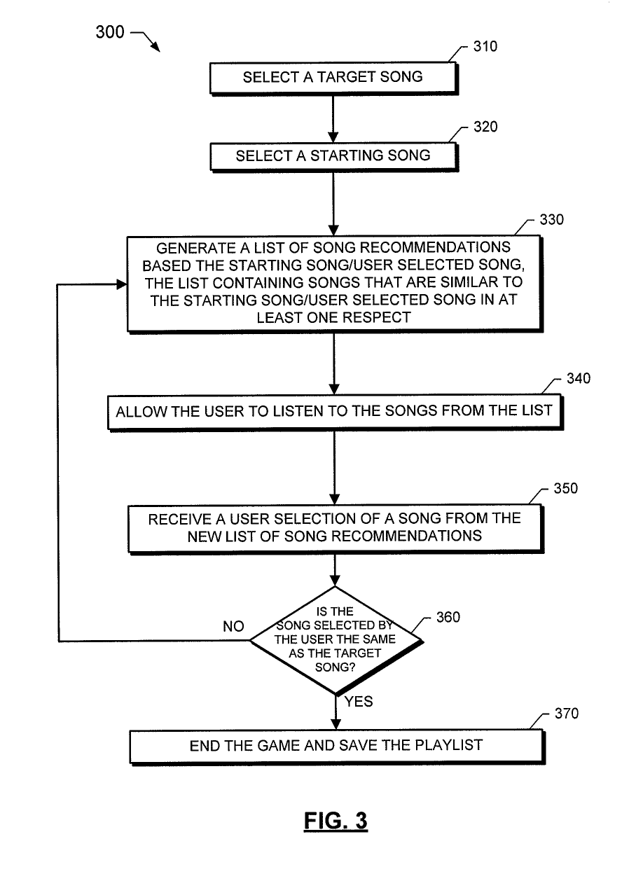

FIG. 3 is a flow diagram illustrating a process 300 that may be executed by the mobile terminal 10 or other electronic device of FIG. 1 in accordance with an exemplary embodiment of the present invention. In this regard, although the mobile terminal is described hereinbelow as performing the various operations, the mobile terminal generally includes means, such as a processing device, e.g., processor 20, for performing each operation. As illustrated by block 310, the process 300 may include the selection of a target song. The target song may be selected automatically by the mobile terminal 10 (or other electronic device) or the target song may be selected by the user. For example, in one embodiment, the mobile terminal 10 randomly selects a song from a collection of audio files stored within the mobile terminal's memory or stored within a remote memory device, such as a remote server. In another exemplary embodiment, the mobile terminal 10 may use the user interface to prompt the user to select or otherwise specify a target song from the collection of audio files stored in the mobile terminal's memory or in a remote memory device.

As illustrated by block 320, the process 300 may further include selecting a starting song. In one embodiment, the starting song is selected by the user. For example, where the process involves trekking across a music collection stored in the mobile terminal's memory, the user may select a starting song from the music collection by specifying the starting song using the mobile terminal's user interface. In another exemplary embodiment, the mobile terminal 10 may provide the user with an initial limited list of songs from which the user can choose the starting song. Such a list may be a random list of songs from the music collection or the list may be generated based on the target song and, perhaps, some selected or predefined level of difficulty. For example, in a more advanced gaming mode the mobile terminal 10 may generate a list of possible starting songs where all of the songs are very far from the target song in the music parameter space. In such an exemplary embodiment, it would be more difficult for the user to find the most direct path from the starting song to the target song.

As illustrated by block 330, after a starting song is selected, either by the user or the mobile terminal 10, the mobile terminal 10 generates a list of song recommendations based on the starting song. In general, at least some, if not all, of the songs in the list are recommended for being similar to the starting song with respect to at least one predetermined music parameter or characteristic. As will be obvious to a person skilled in the art in view of this disclosure, any number of music recommendation systems or computer programs known in the art may be used to generate a list of recommended songs based on the starting song. For example, in one embodiment of the present invention, a computerized system, such as the mobile terminal 10 or some remote system, automatically determines one or more relative attributes about each song or audio file in a collection. For example, a computerized system may examine the audio file and determine physical characteristics of the music relative to the other audio files. For example, such physical characteristics may include information about the audio file's tempo, spectral distribution, instrumentation, frequency, volume range, melody, harmony, rhythm, genre, orchestration, arrangement, lyrics, musical patterns, noise, bandwidth, octave, and the like and how these parameters change over time. In other embodiments of the present invention, the songs or files in the music collection are manually annotated with such physical characteristics about the music and/or with more subjective characteristics of the music such as mood descriptors and other descriptors. The songs may also be annotated with information about the artist, album, date of release, movies that the song was played in, and similar metadata.

In one embodiment, the mobile terminal 10 may include a table having entries for a plurality of songs, the table including information about the songs in terms of one or more of the above described music parameters. For example, the mobile terminal 10 may have a table stored in its memory, the table having entries for many of the more popular songs and having metadata associated with each entry. The metadata may include, for example, mood descriptors, information about the song's genre, artist, band, album, tempo, frequency, and the like, or any other music parameter that may be useful when distinguishing songs from one another. Such information in the database may have been generated at some earlier time automatically by some other computer system or manually by people charged with analyzing music. In another embodiment, the music files themselves have metadata associated with each file, the metadata including information that can be used to determine degrees of similarity between different music files in the collection.

Using one of these exemplary systems or some other system known in the art for determining music parameters for the music files in a music collection, the mobile terminal 10 can then compare the relative music parameters of the songs in the collection and recommend those songs that are similar to the starting song with respect to one or more of the music parameters. For example, the starting song may be characterized as having such attributes as “female vocals,” “high tempo,” “rock,” “heavy lead guitar,” and “power chords.” The mobile terminal 10 may then look through the music collection to find the songs in the collection that have the most in common with the starting song in terms of these predetermined music parameters. In this regard, the mobile terminal 10 may look for all songs having some predetermined level of similarity to the starting song. In other embodiments, however, the mobile terminal 10 may look for the x most similar songs, where x is some predetermined maximum number of songs to present to the user based on the starting song.

Once the mobile terminal 10 determines songs in the collection that are similar to the starting song, the mobile terminal 10 presents this list of recommended songs to the user. For example, the mobile terminal 10 may display the list of songs on its display 28. In one embodiment of the invention, as illustrated by block 340, the user of the mobile terminal 10 may then be able to listen to some or all of the recommended songs so that the user can try to determine which song in the list is most like the target song. In other embodiments of the invention, however, the user may not be able to listen to the songs or the user may only be able to listen to a portion of each song. For example, the difficulty of the game may be able to be adjusted by limiting how much the user can listen to the recommended songs or by limiting the amount of time that the user has to select one of the recommended songs.

As illustrated by block 350, the user will eventually use the user interface of the mobile terminal 10 in order to select a song from the list of recommended songs. As illustrated by block 360, the mobile terminal 10 then compares the selected song to the target song. If the selected song is the target song, then the game is over, as illustrated by block 370. However, if the selected song is not the target song, the process returns to block 330 where the mobile terminal 10 generates a new list of recommended songs. The new list of recommended songs, however, will now be based on the user selected song and, therefore, will contain songs that are considered to be similar to the user selected song. The user will then again try to pick the song from the recommended list of songs that the user thinks is most similar to the target song. The mobile terminal 10 will then make new recommendations based on this user selected song and so on and so forth. This loop continues such that, if the user is making good decisions when selecting the songs, the user gradually moves closer to the target song in the music parameter space. Assuming that the user is moving closer to the target song, at some point the mobile terminal's recommendations will include the target song. At such a point, the user will select the target song and the game will end.

In one embodiment, once the game is over, the user can save, as a playlist, the path that the user took to traverse the music parameter space from the starting song to the target song. In other words, at the end of the process 300, a list of identifiers for each user-selected song may be saved in the order that they were selected in order to form a playlist that smoothly transitions from the starting song to the target song. The user may then be able to share the playlist with other users and other devices. If the other users have electronic devices configured to perform the process 300 of the present invention, then the electronic devices may be configured to repeat the same game (e.g., the same starting song and target song and initial recommendations) on the other user's device so that the other user can try to traverse the same music parameter space from the starting song to the target song in less time than the first user.

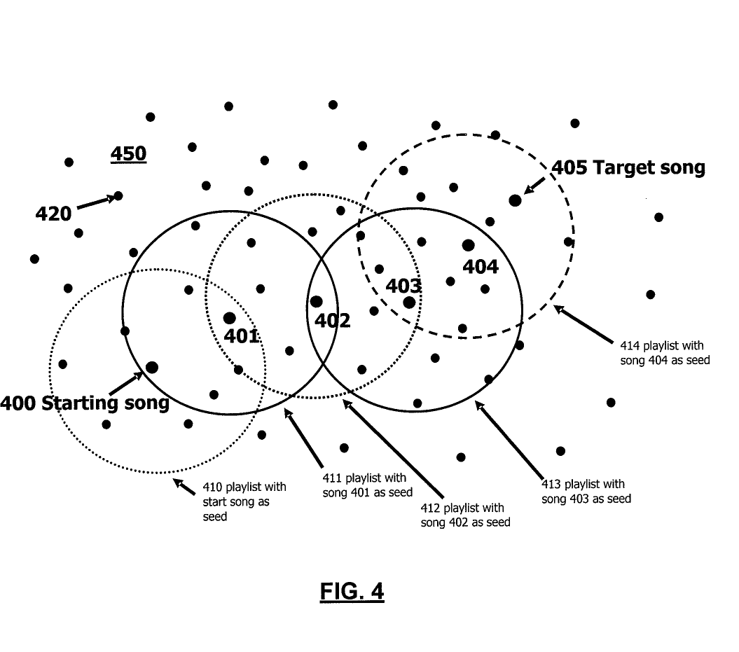

FIG. 4 illustrates, as an example, a possible path in the music parameter space 450 from a starting song 400 to a target song 405 in accordance with an exemplary embodiment of the present invention. In this regard, FIG. 4 illustrates the songs in the music collection as points 420 in a music parameter space 450. Although FIG. 4 illustrates the music parameter space 450 as a two-dimensional space, the music parameter space 450 may have any number of dimensions dependent upon the number and combinations of music parameters used to determine the relative similarities and differences between the individual songs in the collection.

As described above, once a starting song 400 is selected, the mobile terminal 10 presents the user with a plurality of song recommendations (or a “playlist” of recommended songs) that are considered to be similar to the starting song 401. FIG. 4 illustrates these recommendations as the points within the circle 410. As can be seen in FIG. 4, the recommended songs are generally close to the starting song 400 in the music parameter space 450 since they have music parameters that are similar to the starting song's parameters. Some of the song recommendations may be closer to the target song 405 than the starting song 400, while other song recommendations may be further from the target song 405.

In the example shown in FIG. 4, the user selects song 401 from the first set of song recommendations 410. The mobile terminal 10 then recommends a new second set of songs 411 from the music collection, the new second set of songs 411 being similar to the first user-selected song 401. From this second set of songs 411, the user then selects a second user-selected song 402 that the user believes is the most similar to the target song 405 than the other recommended songs. As can be seen in FIG. 4, if the user successfully continues to choose songs from the recommendations that are more similar to the target song 405 than the others in the recommendation, then the user will continue to progress quickly toward the target song 405. Eventually, the user may choose a song, such as song 404, that is so close to the target song 405 in the music parameter space 450 that the mobile terminal 10 will include the target song 405 in its recommendation 414 of songs similar to song 404. In this way, if the user makes good decisions, the user-selected songs will form a smooth transition from the starting song 400 to the target song 405. In this way, the system may be used to generate unique and enjoyable playlists as well as to provide an entertaining game. In fact, in one embodiment of the invention, the system may be configured simply as a unique method for generating playlists. In such a system a target song 405 may not be necessary as the user may simply desire to trek across the music parameter space 450 until the user has a satisfying playlist that forms a smooth and unique path across the music collection in the music parameter space 450.

In an exemplary embodiment, the music collection used in the process is a music collection stored in the mobile terminal 10 or other electronic device. In other embodiments, the music collection is stored in remote memory device, such as a network server or other electronic device. For example, the user may be using a mobile terminal 10 to interact with a remote server, such as an Internet server, and the remote server may be the device that has the music collection and is making the recommendations. In such a system, the remote server may be a system for selling digital music files, or other media files, to the user. In such an embodiment, the system may offer to sell any songs in the final playlist that the user does not already have in his or her personal collection.

In some embodiments of the present invention, the difficulty of the game may be adjustable by the user or automatically as the user plays the game. As described above, the difficulty of the game may be adjusted by choosing a starting song and a target song that are further apart in the music parameter space or by limiting the ability of the user to listen to the songs that are recommended. In another embodiment, the game may be made more difficult by providing more recommendations for the user to choose from each time the mobile terminal 10 makes recommendations.

Furthermore, the mobile terminal 10 may be configured to perform operations that would make the game easier. For example, the mobile terminal 10 may be configured to provide tips about the songs or the music parameters that may help the user determine which song of a list of songs has the most in common with the target song. For example, an exemplary tip may inform the user that: “One of the closest songs to the target song is performed by an artist that died in the 60s in a car accident;” or “One of the closest songs to the target song has a fast rhythm and strong rhythmic components.” The helpfulness of these tips may also be used to adjust the difficulty of the game.

In another exemplary embodiment, the mobile terminal 10 may be configured to display information about the distance to the target song and/or information about whether the user is getting closer to or further from the target song as the user makes song selections during the game. For example, in one embodiment, the mobile terminal 10 (or other electronic device being used to play the game) may be configured to display an illustrated view of the game that may look similar to the illustration of FIG. 4. Such a view would show the music collection in a music parameter space and could show the recommendations, user selections, starting song, and target song as shown in FIG. 4. This would help the user determine where the user is in the music parameter space at any given time during the game and help the user determine whether the user is headed toward or away from the target song.

In one embodiment, the mobile terminal 10 may be configured to adjust the skill level by computing the distance between recommended songs and the target song before presenting the recommended songs to the user. In this way the mobile terminal 10 may make the game easier by only recommending songs that do not deviate much from the path to the target song or the mobile terminal 10 may make the game harder by recommending many songs that would deviate greatly from the shortest path to the target song.

In some embodiments, the amount of time (or steps) that it takes the user to trek across the music parameter space from the starting song to the target song affects the final score. In such an embodiment, the user's score would be higher if the user took a shorter amount of time (or fewer steps) to reach the target song and the user's score would be lower than if the user took a longer amount of time (or more steps) to reach the target song. As noted above, other embodiments may establish different objectives, such as the traversal through the music parameter space from the first song to the target song in a predefined number of steps or in the most number of steps with the scoring being modified accordingly in correspondence to the objective of the game.

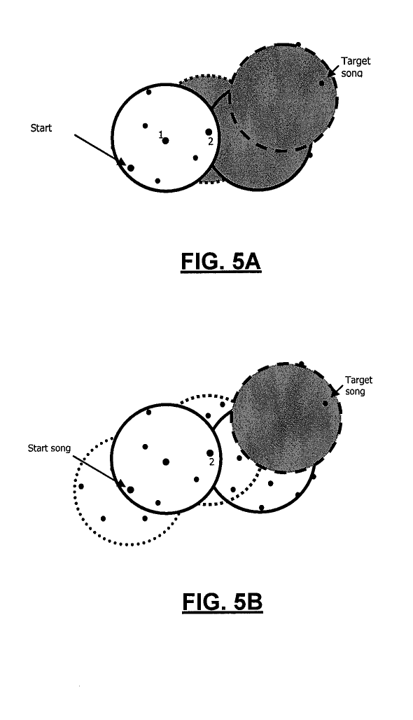

As described above, in one embodiment of the invention, the mobile terminal 10 (or other electronic device) is configured to visualize the music parameter space on a display for the user, such as by displaying an illustration of the music parameter space similar to FIG. 4. In one embodiment, the use may click on the points 420 in the display to listen to and/or select songs in the music parameter space. FIGS. 5A and 5B illustrate an embodiment of such a display where the music parameter space is blacked out in the areas where no songs have been selected or no recommendations have been made. As the user treks to new areas of the music parameter space, more areas of the music parameter space (and, therefore, the music collection) will be exposed to the user. In this way the user can explore a music collection in an entertaining way, all the while generating unique paths and, therefore, unique and interesting playlists.

In addition to or instead of saving the playlist that is formed during the trek from the starting song to the target song, the music selections made by the user may be streamed or otherwise provided, typically in real time or near real time, as a web radio stream, a podcast, audio stream or the like to other users of the music service. As such, other users may enjoy the playlist as the game progresses. The web radio stream, podcast, audio stream or the like may optionally include additional information, e.g. an indication on the relative merits of the current song selection in terms of the game play and/or whether the current song selection brought the user closer or farther away from the target song.

In another exemplary embodiment, a group of persons may simultaneously play the game with same starting and target songs. The winner is generally considered to be the player who gets to the target song in shortest time and/or with the fewest number of intervening song selections. In this case as well, a web radio stream, podcast, audio stream or the like may be constructed of the song selections made by the players. In this case the web radio stream, podcast, audio stream or the like may also include information who was/were the player(s) who made the particular song selection.

While embodiments of the invention are described above in conjunction with music recommendation trekking, other embodiments of the invention are equally applicable to treks or sequential selections of other types of media, such as images, poems, cartoons, animations, videos, or video games, with an intention of traversing the media space from a starting media item to a target media item. Depending upon the type of media, different properties may be employed to measure the similarities or dissimilarities between media selections. In the case of images, the similarity could be measured, e.g., in terms of color, texture, shapes, characters, objects in the image (persons, vehicles, plants, buildings, and so forth), photographer, or the location of the photo shoot. As with music recommendation trekking, the task would again generally be to trek from a starting image to a target image. The resulting sequence of images could be stored as a slideshow, and then shared with other users or posted, e.g., on an online web service.

In the case of poems, the similarity could be measured, e.g., in terms of mood, theme, dramatic situation (who is the speaker, where is he/she located, circumstances), structure of the poem, used images and figures of speech, prosody, rhythm and intonation. The result after the trek would generally be a sequence of poems with an evolving content. The sequence of poems could be stored to be used, e.g., as a gift.

In the case of cartoons, the similarity could be measured, e.g., in terms of amount of speech balloons, number of panels and their orientation, amount and type of characters, topic of storyline, colors, place of events, artist, and so on. Again, by playing the trek from one comic to another the player could generate a personalized comic book with a sequence of comic strips with related content.

In the case of videos, the similarity could be measured, e.g., in terms of place of events, mood, storyline, actors, director, objects in the video, and so on. For example, the user could select to trek from one short comedy video clip to another and create an entertaining sequence of comedy video clips with related content in a party, for example.

In the case of video games, the similarity could be measured, e.g., in terms of avatars (whether they are persons, their gender, or animals, monsters), genre (action, sports, arcade, etc.), amount and type of objects in the game, its general difficulty level, method of game play, types of sounds, music included in the games, or programmers. By making a trek from one game to another the player could generate a personalized sequence of, e.g., short minigames that could then be played, e.g., in a party.

In the above embodiments, the method and apparatus may provide the possibility to purchase the resulting sequence of media items after the game play. For example, a link to an online store selling the items may be provided along with a list of items that the user may purchase to recreate the sequence. The method and apparatus may also provide a list of the sequence of items which a user may share with others and together, or without, the purchasing link, the others may purchase a selection of the items as well.

In general, the attributes or properties describing different media items, such as the music parameters and the other attributes described above in conjunction with other types of media, could be stored either in a separate metadata database or as metadata attached to the media files. The metadata may describe the media attributes, the metadata may contain distances between all the media items in the database, and/or the metadata may describe, e.g., the n closest other media items for each item in the database.

The functions described above with respect to the various embodiments of the present invention may be carried out in many ways. For example, any suitable means for carrying out each of the functions described above may be employed to carry out embodiments of the invention. According to one aspect of the present invention, all or a portion of the system generally operates under control of a computer program product. The computer program product for performing the various processes and operations of embodiments of the present invention includes a computer-readable storage medium, such as a non-volatile storage medium, and computer-readable program code portions, such as a series of computer instructions, embodied in the computer-readable storage medium. For example, in one embodiment, the processor of the mobile terminal 10 generally operates under the control of a computer program product to execute the music recommendation trekking process 300 illustrated in FIG. 3.

In this regard, FIG. 3 is a flowchart of operations performed by methods, systems, devices, and computer program products according to embodiments of the present invention. It will be understood that each block of a flowchart or each step of a described method can be implemented by computer program instructions. These computer program instructions may be loaded onto a computer or other programmable apparatus to produce a machine, such that the instructions which execute on the computer or other programmable apparatus create means for implementing the functions specified in the described block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the described block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the described block(s) or step(s).

It will also be understood that each block or step of a described herein, and combinations of blocks or steps, can be implemented by special purpose hardware-based computer systems which perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An apparatus comprising:
a processing device configured to receive a selection of a first selected media item,
wherein the processing device is configured to generate a first plurality of media items based on the first selected media item,
wherein the processing device is also configured to receive a selection of a second selected media item from among the first plurality of media items, and
wherein the processing device is further configured to generate a second plurality of media items based on the second selected media item.

2. The apparatus of claim 1, wherein the processing device is configured to receive a third selected media item from among the second plurality of media items, and wherein the processing device is configured to generate a third plurality of media items based on the third selected media item if the third selected media item is not a predetermined target media item.

3. The apparatus of claim 2, wherein the processing device does not provide the user with a third plurality of media items based on the third selected media item if the third selected song is the target media item.

4. The apparatus of claim 1, wherein the processing device is configured to generate the first plurality of media items based on the first selected media item by identifying a plurality of media items that are similar to the first selected media item with respect to at least one predetermined property.

5. The apparatus of claim 4, wherein the processing device is configured to generate the second plurality of media items based on the second selected media item by identifying a plurality of media items that are similar to the second selected media item with respect to at least one predetermined property.

6. The apparatus of claim 4, wherein the media item is a song, and wherein the at least one predetermined property includes at least one of the song's tempo, frequency, genre, rhythm, lyrics, instrumentation, melody, arrangement, or mood.

7. The apparatus of claim 1, wherein the processing device repeatedly generates a plurality of media items based on the previous selected media item until the selected media item is the same media item as a predetermined target media item.

8. The apparatus of claim 1, further comprising a memory for storing the media items from which the processing device generates the first and second plurality of media items.

9. The apparatus of claim 1, wherein the media item is a song, and wherein the apparatus further comprises a memory for storing a representation of the first and second songs as a playlist.

10. A method comprising:
receiving a selection of a first selected media item;
generating a first plurality of media items based on the first selected media item;
receiving a selection of a second selected media item from among the first plurality of media item; and
generating a second plurality of media items based on the second selected media item.

11. The method of claim 10, further comprising:
receiving a third user selected media item from among the second plurality of media items; and
providing the user with a third plurality of media items based on the third user selected media item if the third user selected media item is not a predetermined target media item.

12. The method of claim 10, wherein generating the first plurality of media items based on the first selected media item comprises identifying a plurality of media items that are similar to the first selected media item with respect to at least one predetermined property.

13. The method of claim 12, wherein generating the second plurality of media items based on the second selected media item comprises identifying a plurality of media items that are similar to the second selected media item with respect to at least one predetermined property.

14. The method of claim 12, wherein the media item is a song, and wherein the at least one predetermined property includes at least one of the song's tempo, frequency, genre, rhythm, lyrics, instrumentation, melody, arrangement, or mood.

15. The method of claim 10, further comprising:
repeatedly generating a plurality of media items based on the previous selected media item until the selected media item is the same media item as a predetermined target media item.

16. The method of claim 10, wherein the media item is a song, and wherein the method further comprises:
generating a playlist including a representation of each selected song.

17. A computer program product comprising at least one computer-readable storage medium having computer-readable program code logic stored therein, the computer-readable program code logic comprising:
a first code logic configured for receiving a selection of a first selected media item;
a second code logic configured for generating a first plurality of media items based on the first selected media item;
a third code logic configured for receiving a selection of a second selected media item from among the first plurality of media items; and
a fourth code logic configured for generating a second plurality of media items based on the second selected media item.

18. The computer program product of claim 17, further comprising:
a fifth code logic configured for receiving a third selected media item from among the second plurality of media items; and
a sixth code logic configured for generating a third plurality of media items based on the third selected media item if the third selected media item is not a predetermined target media item.

19. The computer program product of claim 17, wherein the second code logic for generating the first plurality of media items based on the first selected media item comprises code logic configured for identifying a plurality of media items that are similar to the first selected media item with respect to at least one predetermined property.

20. The computer program product of claim 19, wherein the fourth code logic for generating the second plurality of media items based on the second selected media item comprises code logic configured for identifying a plurality of media items that are similar to the second selected media item with respect to at least one predetermined property.

21. The computer program product of claim 19, wherein the media item is a song, and wherein the at least one predetermined property includes at least one of the song's tempo, frequency, genre, rhythm, lyrics, instrumentation, melody, arrangement, or mood.

22. The computer program product of claim 17, further comprising code logic configured for repeatedly generating a plurality of media items based on the previous selected media item until the user selected media item is the same media item as a predetermined target media item.

23. The computer program product of claim 17, wherein the media item is a song, and wherein the computer-readable program code logic further comprises:
code logic configured for generating a playlist including a representation of each selected song.

24. An apparatus comprising:
means for receiving a selection of a first selected media item;
means for generating a first plurality of media items based on the first selected media item;
means for receiving a selection of a second selected media item from among the first plurality of media items; and
means for generating a second plurality of media items based on the second selected media item.

25. The apparatus of claim 24, wherein the means for generating the first plurality of media items based on the first selected media item comprises means for identifying a plurality of media items that are similar to the first selected media item with respect to at least one predetermined property.

26. The apparatus of claim 25, wherein the media item is a song, and wherein the at least one predetermined property includes at least one of the song's tempo, frequency, genre, rhythm, lyrics, instrumentation, melody, arrangement, or mood.

27. The apparatus of claim 24, further comprising:
means for repeatedly generating a plurality of media items based on the previous selected media item until the selected media item is the same media item as a predetermined target media item, wherein the means for repeatedly generating a plurality of media items comprises both the means for generating the first plurality of media items and the means for generating the second plurality of media items.

28. The apparatus of claim 24, wherein the media item is a song, and further comprising:
means for generating a playlist including a representation of each selected song.
